(19) United States
(12) Patent Application Publication
(10) Pub. No.: US 2025/0059625 A1
(43) Pub. Date: Feb. 20, 2025

(54) METHOD FOR EXTRACTING LITHIUM FROM CLAY AND OTHER MATERIALS IN A CHLORIDE SOLUTION USING INDIVIDUALIZED PRETREATMENTS

(71) Applicant: Cypress Holdings (Nevada), Ltd., Twin Falls, ID (US)

(72) Inventors: Todd S. Fayram, Butte, MT (US); William W. Willoughby, Buhl, ID (US)

(21) Appl. No.: 18/795,433

(22) Filed: Aug. 6, 2024

Related U.S. Application Data
(60) Provisional application No. 63/532,438, filed on Aug. 14, 2023.

(51) Int. Cl. C22B 26/12; B01D 15/08; B01D 25/12; B01D 61/02; B01D 61/04; C01D 15/08; C22B 1/24; C22B 3/10; C22B 3/24; C22B 3/44

(52) U.S. Cl. CPC C22B 26/12; B01D 15/08; B01D 25/12; B01D 61/025; B01D 61/04; C01D 15/08; C22B 1/24; C22B 3/10; C22B 3/24; C22B 3/44; B01D 2311/04

(57) ABSTRACT

A method for extracting lithium from lithium-containing material including reducing the material to base particle size; mixing the base particles with an aqueous solution of a first base; heating the slurry to a temperature in a range of 60° to 75° C. for 0.5 to four hours; adding hydrochloric acid to the heated slurry until it reaches a pH level of −1.0 to 0.00; maintaining the acid-treated slurry at 60° to 75° C. for 0.5 to four hours; cooling the acid-treated slurry to near-ambient temperature and treating it with a second base until the acid-treated slurry reaches a pH of 7.5; precipitating deleterious base metals from the direct lithium extracted solution and combining the deleterious base metals with the leached clay solids; and passing the direct lithium extracted solution and solid tailings materials through a filter.

### CROSS-REFERENCE TO RELATED APPLICATION

Pursuant to 35 U.S.C. Section 119(e), this application claims priority back to U.S. Patent Application No. 63/532,438 filed on Aug. 14, 2023. The contents of the '438 application are incorporated herein by reference.

### BACKGROUND OF THE INVENTION

### A. Field of the Invention

The present invention relates generally to the extraction of lithium from lithium-containing materials, ores and minerals having low concentrations of lithium by weight. More particularly, the present invention involves a process for the recovery of lithium from such material by creating a slurry, reducing the lithium-containing material to its base particle size, reacting the slurry with a sodium, potassium and/or calcium hydroxide base, further reacting it with hydrochloric acid, treating the leached slurry with a sodium, potassium and/or calcium hydroxide base, separating the liquid and solid phases, removing deleterious elements from the liquid solution and concentrating it via an adsorption process and reverse osmosis, and finally heating and treating the solution with an alkali carbonate, thereby precipitating lithium carbonate, which is then filtered and washed with hot water to recover solid lithium carbonate.

### B. Description of the Related Art

A number of processes have been proposed to recover lithium from lithium-containing minerals. For example, U.S. Pat. No. 2,983,576 (Robinson, 1959) discloses a process by which lithium is recovered from “alpha” spodumene. In this context, the term “alpha spodumene” refers to a white to yellowish mineral occurring in prismatic crystals. It has a general formula of LiAlSi2O6. Usually, the ore contains about 0.1-4 percent by weight of Li2O. This patent describes a method for recovering lithium from a finely ground concentrated spodumene ore by using sulfuric acid and heating the alpha spodumene at high temperature, namely, 200° to 300° C. and pressure 300 to 500 psi. In this manner, the alpha spodumene is converted to “beta” spodumene with 45% sulfuric acid by volume. Recovery of 70 to 90% was obtained depending on the grind size of the spodumene concentrate. The process described in the '576 patent is disadvantageous because it includes several steps that involve relatively high temperatures and pressures.

In one application of the present invention, the source of lithium is a complex smectite-illite lithium-bearing claystone. One such major deposit of claystone is in Clayton Valley in south central Nevada. Clayton Valley is currently the only commercial lithium brine source and is the only primary lithium producer in the United States. The claystone is a complex intimate physical mixture of solid illite and smectite clay components that is typically 60 to 65% illite clay and 25 to 30% smectite clay. Davis. Friedman, and Gleason discuss the origins of the Clayton Valley geology, mineral brines and their source in Origin of the Lithium-Rich Brine. Clayton Valley. NV U.S. Geological Survey File Bulletin No. 1622 (1986), and they detail the geology of Clayton Valley. Previous attempts to extract lithium from these claystones by hydrometallurgical procedures have been unsuccessful in Clayton Valley.

One such example is May et al., Extracting Lithium from Clays by Roast Leach Treatment, ROI 8432. U.S. Bureau of Mines Report (1980), in which the authors discuss an investigation of the extraction of lithium from clay from the northern and southwestern sections of the McDermitt Caldera. Extensive research was conducted to study lithium extraction from McDermitt B clay by roasting in an HCl—H2O atmosphere.

The research was prompted by several chloride roasting techniques described in the literature. For example, a method for chlorinating lithium by mixing lithium-bearing ore with carbon and roasting with chlorine was proposed by MacDougall. Another method involving the chlorination of lepidolite with HCl was investigated by Lof and Lewis, who found that lithium extraction increased with the chlorination temperature up to 950° C., whereupon the lepidolite began to melt, and the reaction rate decreased rapidly. Above 900° C., a large part of the LiCl was recovered as a volatile product. Additions of water vapor or air to the HCl gas resulted in decreased lithium extraction. U.S. Bureau of Mines research found that proper control of HCl—H2O ratios and roast conditions minimized the extraction of impurities from chlorinated calcines. In addition, data showed that the formation of soluble lithium was greatly enhanced when the McDermitt clay was mixed with CaCO3 before chlorination. The research was reported by Davidson and May, and a patent was granted on the chlorination roast procedure. See U.S. Pat. No. 4,285,914 entitled “Recovery of Lithium From Low-Grade Ores.”

The recovery of lithium from various sources is also reviewed in Lithium Process Chemistry by Changes and Swiatowska, published in 2015 by Elsevier. Inc. of Walthen, Maine. None of the references described above disclose methods comparable in effectiveness of the present invention to extract lithium from low grade lithium ores.

### BRIEF SUMMARY OF THE INVENTION

The present invention is a method for extracting lithium from a lithium-containing material comprising the steps of: reducing the lithium-containing material to base particle size using an attrition scrubber to produce base particles: mixing the base particles with an aqueous solution of a first base to form a slurry, wherein the first base is selected from the group consisting of sodium hydroxide, potassium hydroxide, calcium hydroxide, or any combination of sodium hydroxide, potassium hydroxide, and calcium hydroxide; heating the slurry in a first tank to a temperature in a range of 60° to 75° C. for 0.5 to four hours; delivering the heated slurry to a second tank in which the heated slurry leaves the first tank at a certain temperature and is maintained at the certain temperature in the second tank; adding hydrochloric acid to the heated slurry until the heated slurry reaches a pH level of −1.0 to 0.00, thereby generating an acid-treated slurry; maintaining the acid-treated slurry at a temperature of 60° to 75° C. for 0.5 to four hours; delivering the acid-treated slurry to a third tank in which the acid-treated slurry is cooled to near-ambient temperature and treated with a second base until the acid-treated slurry reaches a pH of approximately 7.5, thereby generating a direct lithium extracted solution and leached clay solids, wherein the second base is selected from the group consisting of sodium hydroxide, potassium hydroxide, calcium hydroxide, or any combination of sodium hydroxide, potassium hydroxide, and calcium hydroxide; precipitating deleterious base metals from the direct lithium extracted solution in a first precipitation tank and combining the deleterious base metals with the leached clay solids to form a solid tailings material; and passing the direct lithium extracted solution and the solid tailings materials through a filter that is configured to separate the direct lithium extracted solution from the solid tailings material.

In one embodiment, the lithium-containing material is an illite clay ore. In another embodiment, the lithium-containing material is a smectite clay ore. In yet another embodiment, the lithium-containing material is an ore containing both illite clay ore and smectite clay ore.

In a preferred embodiment, the base particles are 50 microns or less in size. Preferably, the concentration of the first base is within a range of 0.01 N to IN. The concentration of the first base is preferably approximately 0.5 N. In a preferred embodiment, the slurry contains 15% to 35% solids. Preferably, the slurry contains approximately 30% solids.

In a preferred embodiment, the slurry is heated in the first tank to a temperature of approximately 60° for approximately two hours. Preferably, the heated slurry reaches a pH level of approximately −0.5 in the second tank. The acid-treated slurry is maintained at a temperature of approximately 60° for approximately two hours in the second tank. In a preferred embodiment, the step of passing the direct lithium extracted solution and the solid tailings materials through a filter that is configured to separate the direct lithium extracted solution from the solid tailings material involves the use of multiple plate and frame filters.

In another preferred embodiment, the invention further comprises the steps of: treating the direct lithium extracted solution to an adsorption process to remove alkaline earth metal impurities from the direct lithium extracted solution, thereby generating a purified lithium-bearing solution; and passing the purified lithium-bearing solution through at least one reverse osmosis unit to increase concentration of the lithium element in the purified lithium-bearing solution. In another preferred embodiment, the invention further comprises the step of: precipitating lithium carbonate out of the purified lithium-bearing solution using sodium carbonate, thereby generating a spent lithium solution and a solid lithium carbonate. In another preferred embodiment, the invention further comprises the step of: adding a third base to the spent lithium solution in a second precipitation tank to remove remaining deleterious elements from the spent lithium solution; wherein the third base is selected from the group consisting of sodium hydroxide, potassium hydroxide, or any combination of sodium hydroxide and potassium hydroxide.

In a preferred embodiment, the invention further comprises the step of: passing the spent lithium solution and the deleterious elements through multiple plate and frame filters. In another preferred embodiment, the invention further comprises the step of: delivering the spent lithium solution to a chlor-alkali plant that is configured to generate a hydrochloric acid solution and a sodium hydroxide solution from the spent lithium solution through an electrolytic process. In another preferred embodiment, the invention further comprises the step of recycling unused spent lithium solution back to the attrition scrubber.

### BRIEF DESCRIPTION OF THE DRAWINGS

FIG. 1 is a flow diagram that illustrates the various steps in the present invention.

### DETAILED DESCRIPTION OF INVENTION

### A. Overview

Lithium and its compounds have a variety of commercial uses ranging from lightweight electrical storage batteries to medications for the treatment of depression and other disorders in human beings. These uses include rechargeable batteries for mobile phones, laptops, digital cameras and electric vehicles. Lithium carbonate is used to treat bipolar disorder. Lithium hydroxide is used in high-density and high-capacity electric vehicle batteries.

Lithium is typically found in rock or clay ores or in briny water. Conventional methods of extraction of lithium from ores involve sulfuric acid leaching and/or high-temperature processing, which tends to be an expensive process that produces significant deleterious waste products such as gypsum. The present invention provides a novel process for obtaining lithium from material having a low concentration of lithium in which lithium is recovered without the use of high temperatures and pressures and at relatively low cost.

The present invention relates to the separation of lithium from lithium-containing materials, primarily lithium claystone ores, having about 0.02 to 2.0 percent lithium by weight. The method of the present invention involves the following steps: (1) mixing the lithium-containing material with an aqueous base containing sodium hydroxide, potassium hydroxide and/or calcium hydroxide in an attrition scrubber to create an attritioned slurry and reduce the overall material size to the base particle size of the clay (approximately 1 to 40 micron(s)); (2) delivering the attritioned slurry to a leach tank, heating the attritioned slurry to 50° to 100° C., maintaining it at that temperature for 0.5 to 4 hours, acidifying the attritioned slurry with aqueous 36% hydrochloric acid at 1 to 6% acid by volume at 100% acid basis and a pH value of less than −0.5, thereby generating a heated acidified slurry; (3) delivering the heated acidified slurry to a first precipitation tank in which the heated acidified slurry is treated with sodium hydroxide, potassium hydroxide and/or calcium hydroxide to precipitate deleterious base metals out of the solution within the heated acidified slurry, thereby generating a direct lithium extracted solution and a solid tailings material; (4) passing the direct lithium extracted solution and the solid tailings material through multiple plate and frame filters that are configured to separate the solid tailings material from the direct lithium extracted solution; (5) passing the direct lithium extracted solution through one or more lithium recovery columns that are configured to generate a purified lithium solution out of the direct lithium extracted solution through an adsorption process, thereby generating a purified lithium-bearing solution; (6) passing the purified lithium-bearing solution through at least one reverse osmosis unit to increase concentration of the lithium element in the purified lithium-bearing solution; (7) precipitating lithium carbonate out of the lithium-bearing solution using sodium carbonate, thereby generating a spent lithium solution and a solid lithium carbonate; (8) adding sodium hydroxide and/or potassium hydroxide to the spent lithium solution in a second precipitation tank to remove any remaining deleterious elements from the spent lithium solution; and (9) passing the spent lithium solution and the deleterious elements through multiple plate and frame filters; (10) delivering the spent lithium solution to a chlor-alkali plant that is configured to generate a hydrochloric acid solution and a sodium hydroxide solution from the spent lithium solution through an electrolytic process; and (11) recycling any unused spent lithium solution back to the attrition scrubber.

### B. Detailed Description of the Invention

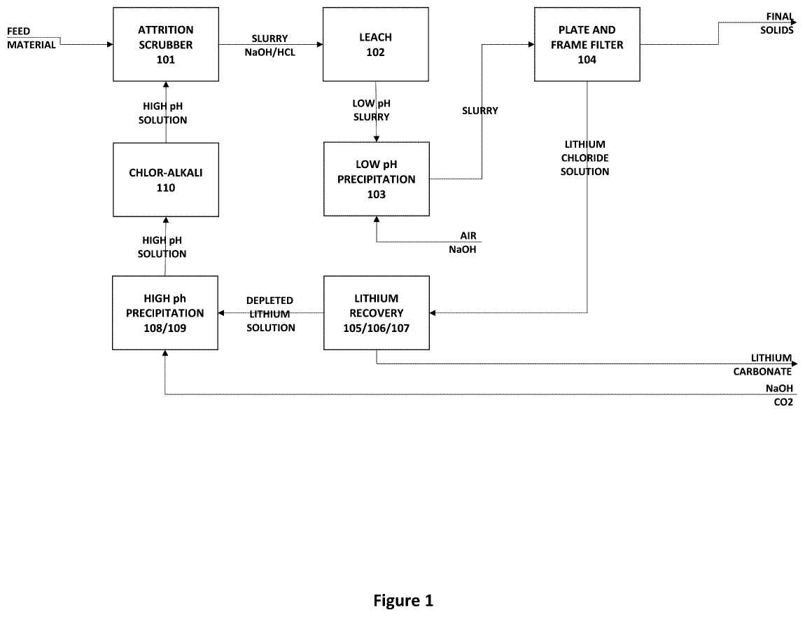

As shown in FIG. 1, the first step 101 in the method of the present invention is to reduce the lithium-containing material (hereinafter referred to broadly as “ore”) to its base particle size. The ores may include, but are not limited to, illite clay ores, smectite clays ores, or a clay ore that contains a combination of both. As used herein, the term “illite” means any group of mica-type clay minerals widely distributed in marine shales and related sediments. Illite contains more water and less potassium than true micas, but it has a mica-like sheet structure and is poorly crystallized. As used herein, the term “smectite” refers to a broad category of dioctahedral (such as montmorillonite) and trioctahedral (saponite) clay minerals. The smectite chemical varieties are characterized by swelling properties and high cation-exchange capacities.

The reduction in size of the ore may be accomplished by using any type of attrition scrubbing that breaks the particles down to their natural size, which is typically less than 50 microns in size. The useful particles are those that have an average size of about 30 microns or finer. The resulting ore particles are then mixed with an aqueous solution of a strong base to form a slurry. In a preferred embodiment, the base is sodium hydroxide, potassium hydroxide and/or calcium hydroxide. The concentration of the base is within a range of 0.01 to IN; in a preferred embodiment, the concentration of the base is about 0.5 N. The slurry usually contains 15% to 35% solids; in a preferred embodiment, the slurry contains 30% solids.

The next step 102 (referred to as “Leach” in FIG. 1) comprises two tanks. The slurry is first transferred to and heated in a first tank to a temperature in the range of 60° to 75° C. (preferably 60° C.) for 0.5 to 4 hours. In a preferred embodiment, the slurry is heated to a temperature of 60° C. and is maintained at that temperature for approximately 2 hours. Note that the slurry in the first tank has a pH level of 7.0 to 9.5. Next, the slurry is delivered to a second tank in which the temperature of the slurry is maintained at the same temperature at which it exited the first tank. In the second tank, hydrochloric acid is added to the slurry until it reaches a desired pH level. The pH of the slurry is preferably brought down to a range of −1.0 to 0.0; in a preferred embodiment, the pH of the slurry is brought to pH of −0.5. The acid-treated slurry is then maintained at a temperature of 60° to 75° C. for 0.5 to 4 hours; in a preferred embodiment, the acid-treated slurry is maintained at 60° C. for 2 hours in the second tank. The pH remains constant as new slurry enters the second tank and leached slurry leaves the second tank (see next step) over this time frame.

In the next step, the slurry is delivered to a third tank 103 (referred to in FIG. 1 as the “Low pH Precipitation” tank), where it is allowed to cool to near-ambient temperature and treated with a strong base, which is preferably sodium hydroxide (NaOH), potassium hydroxide (KOH), and/or calcium hydroxide (Ca(OH)₂) to a pH of about 7.5. In this tank, the deleterious base metals (e.g., Fe, Mn, Ba, and Al) are precipitated from the solution and mixed with the leached clay solids to form a mixed solid (referred to herein as the “solid tailings material”). This step takes advantage of the fact that lithium is very soluble and will not precipitate across the entire pH scale of 0-13 pH units; in other words, the lithium stays in solution.

In the next step, the direct lithium extracted solution and solid tailings material that are generated in the previous step are passed through a filter 104 that separates the direct lithium extracted solution from the solid tailings material. In a preferred embodiment, the filter step involves multiple plate and frame filters. Plate and frame filters are commonly used for solid-liquid separation. These types of filters consist of a series of filter plates and frames arranged alternately, with a filter cloth and/or paper in between them.

In the next step, the direct lithium extracted solution (also referred to as “aqueous filtrate”) is treated in a lithium recovery step by adsorption 105 and reverse osmosis 106, which concentrates and removes alkaline earth metal impurities from the solution, thereby creating a relatively pure lithium chloride solution. The lithium chloride solution is subsequently heated to between 70° and 90° C. for 0.5 to one hour; in a preferred embodiment, the lithium carbonate is heated to 90° C. for 45 minutes. Sodium carbonate is then added to the lithium chloride solution to precipitate lithium carbonate 107. The formed lithium carbonate is removed by filtration using multiple plate and frame filters. The remaining solution is referred to herein as depleted lithium chloride solution.

In the next step 108, a base (that is, sodium hydroxide and/or potassium hydroxide) is added to the depleted lithium chloride solution to remove any remaining deleterious elements, including calcium and magnesium. The precipitated solids, as well as the depleted lithium chloride solution, are then passed through multiple plate and frame filters 109. The precipitated solids are then collected and sent to waste. The depleted (and filtered) lithium chloride solution is then sent to chlor-alkali step 110.

In the chlor-alkali step 110, the depleted lithium chloride solution that was filtered in the previous step is sent through multiple membranes in electrolytic cells to generate chlorine gas, hydrogen gas and sodium hydroxide. The chlorine and hydrogen gases are burned to create hydrochloric acid, which is recycled back into the system (see leach step 102). The sodium hydroxide is recycled back into the system and used in connection with the attrition scrubber 101 and low pH precipitation 103 steps described above. The depleted lithium chloride solution is now depleted of chlorides and alkali earth metals and has become water (H₂O), which is recycled back into the attrition scrubber.

### C. Example

In this example, lithium was extracted from illite-smectite clay (clay comprised of both illite and smectite clay) using sodium hydroxide and hydrochloric acid in a pilot plant specifically designed for lithium recovery. Specifically, the illite-smectite clay was added to the pilot plant at approximately one ton per day. The clay was mined from the central portion of the Angel Island lithium clay deposit located near Clayton Valley, Nevada. The clay was added to the attrition scrubber along with sodium hydroxide solution recycled from the high pH1 precipitation solution and subjected to attrition scrubbing for 20 minutes at 30% solids by weight in the slurry. The obtained slurry was filtered on a round vibrating screen to remove plastic and large oversize material. The filtered slurry had an average particle size of five microns (containing an average grade of 0.113% lithium).

The slurry was then sent to the first leaching tank with approximately 1 N (1 gram-equivalent weight of solute per liter of solution) sodium hydroxide in solution. The slurry was brought to a temperature of 60° C. and maintained at that temperature for one hour. The heated slurry was then sent to the second leach tank. In the second leach tank, 35% hydrochloric acid was added to achieve a slurry strength of 4% hydrochloric acid in the slurry. The pH of the slurry containing about 28% solids after the addition of the acid was maintained at −0.5 pH units and a temperature of 60° C. for two hours with continuous stirring. No other solution or acid was added.

After acid leaching, the slurry was sent to the low precipitation tank in which sodium hydroxide is added to bring the slurry to a pH of 7.5. The slurry remained in this tank for approximately seven to ten minutes, during which time precipitation was completed. The slurry was then sent to a plate and frame filter and filtered to remove deleterious precipitated solids and leached clay. The solids were disposed of as tailings. The solution obtained from the filtering step was a lithium chloride solution that contained approximately 200 to 300 ppm lithium. The addition of sodium hydroxide solution in the first tank improved the recovery of lithium from about 79% to 85%. The lithium chloride solution was then sent to lithium recovery. Next, the spent lithium chloride solution was sent to high pH precipitation where the remaining deleterious elements, including calcium and magnesium, were precipitated. The precipitated solids, as well as the depleted lithium chloride solution, were then passed through a centrifuge. The precipitated solids were collected and sent to waste. In this example, the depleted (and filtered) lithium chloride solution was then back to leach as recycle. In a full-size plant, the depleted lithium chloride solution would be sent to chlor-alkali.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

We claim:

1. A method for extracting lithium from a lithium-containing material comprising the steps of:
(a) reducing the lithium-containing material to base particle size using an attrition scrubber to produce base particles;
(b) mixing the base particles with an aqueous solution of a first base to form a slurry;
wherein the first base is selected from the group consisting of sodium hydroxide, potassium hydroxide, calcium hydroxide, or any combination of sodium hydroxide, potassium hydroxide, and calcium hydroxide:
(c) heating the slurry in a first tank to a temperature in a range of 60° to 75° C. for 0.5 to four hours;
(d) delivering the heated slurry to a second tank in which the heated slurry leaves the first tank at a certain temperature and is maintained at the certain temperature in the second tank;
(e) adding hydrochloric acid to the heated slurry until the heated slurry reaches a pH level of −1.0 to 0.00, thereby generating an acid-treated slurry;
(f) maintaining the acid-treated slurry at a temperature of 60° to 75° C. for 0.5 to four hours;
(g) delivering the acid-treated slurry to a third tank in which the acid-treated slurry is cooled to near-ambient temperature and treated with a second base until the acid-treated slurry reaches a pH of approximately 7.5, thereby generating a direct lithium extracted solution and leached clay solids;
wherein the second base is selected from the group consisting of sodium hydroxide, potassium hydroxide, calcium hydroxide, or any combination of sodium hydroxide, potassium hydroxide, and calcium hydroxide;
(h) precipitating deleterious base metals from the direct lithium extracted solution in a first precipitation tank and combining the deleterious base metals with the leached clay solids to form a solid tailings material; and
(i) passing the direct lithium extracted solution and the solid tailings materials through a filter that is configured to separate the direct lithium extracted solution from the solid tailings material.

2. The method of claim 1, wherein the lithium-containing material is an illite clay ore.

3. The method of claim 1, wherein the lithium-containing material is a smectite clay ore.

4. The method of claim 1, wherein the lithium-containing material is an ore containing both illite clay ore and smectite clay ore.

5. The method of claim 1, wherein the base particles are 50 microns or less in size.

6. The method of claim 1, wherein the concentration of the first base is within a range of 0.01 N to 1 N.

7. The method of claim 6, wherein the concentration of the first base is approximately 0.5 N.

8. The method of claim 1, wherein the slurry contains 15% to 35% solids.

9. The method of claim 8, wherein the slurry contains approximately 30% solids.

10. The method of claim 1, wherein the slurry is heated in the first tank to a temperature of approximately 60° for approximately two hours.

11. The method of claim 1, wherein the heated slurry reaches a pH level of approximately −0.5 in the second tank.

12. The method of claim 1, wherein the acid-treated slurry is maintained at a temperature of approximately 60° for approximately two hours in the second tank.

13. The method of claim 1, wherein the step of passing the direct lithium extracted solution and the solid tailings materials through a filter that is configured to separate the direct lithium extracted solution from the solid tailings material involves the use of multiple plate and frame filters.

14. The method of claim 1, further comprising the steps of:
(j) treating the direct lithium extracted solution to an adsorption process to remove alkaline earth metal impurities from the direct lithium extracted solution, thereby generating a purified lithium-bearing solution; and
(k) passing the purified lithium-bearing solution through at least one reverse osmosis unit to increase concentration of the lithium element in the purified lithium-bearing solution.

15. The method of claim 14, further comprising the step of:
(l) precipitating lithium carbonate out of the purified lithium-bearing solution using sodium carbonate, thereby generating a spent lithium solution and a solid lithium carbonate.

16. The method of claim 15, further comprising the step of:
(m) adding a third base to the spent lithium solution in a second precipitation tank to remove remaining deleterious elements from the spent lithium solution;
wherein the third base is selected from the group consisting of sodium hydroxide, potassium hydroxide, or any combination of sodium hydroxide and potassium hydroxide.

17. The method of claim 16, further comprising the step of:
(n) passing the spent lithium solution and the deleterious elements through multiple plate and frame filters.

18. The method of claim 17, further comprising the step of:
(o) delivering the spent lithium solution to a chlor-alkali plant that is configured to generate a hydrochloric acid solution and a sodium hydroxide solution from the spent lithium solution through an electrolytic process.

19. The method of claim 18, further comprising the step of:
(p) recycling unused spent lithium solution back to the attrition scrubber.
